(19) United States
(12) Patent Application Publication
(10) Pub. No.: US 2017/0186065 A1
(43) Pub. Date: Jun. 29, 2017

(54) System and Method of Product Selection for Promotional Display

(71) Applicant: Alibaba Group Holding Limited, Grand Cayman (KY)

(72) Inventors: Shenghuo ZHU, Bellevue, WA (US); Jian XUE, Seattle, WA (US); Ling YAN, Hangzhou (CN); Rong JIN, Seattle, WA (US); Shijun WANG, Seattle, WA (US)

(73) Assignee: Alibaba Group Holding Limited

(21) Appl. No.: 14/982,809

(22) Filed: Dec. 29, 2015

(51) Int. Cl. G06Q 30/06; G06Q 30/02; G06F 17/30; H04L 29/08

(52) U.S. Cl. CPC G06Q 30/0621; H04L 67/306; G06Q 30/0201; G06Q 30/0643; H04L 67/22; G06Q 30/0255; G06Q 30/0253; G06F 17/3053

(57) ABSTRACT

A method for selecting a product to display on a webpage of an e-commerce website. Online user behavior data associated with a plurality of merchants selling products on the webpage is obtained. The behavior data is user actions performed online with respect to merchants. The behavior data is analyzed to determine a most relevant group of the users for each merchant. The most relevant group is compared to a targeted group of the webpage to determine a rate of overlap for each merchant. The rate of overlap represents a percentage of the most relevant group that matches the targeted group. A top merchant is selected based on the highest rate of overlap. A top product being sold by the top merchant is selected to display on the webpage. The top product is displayed on the webpage of the e-commerce web site to an end user.

### BACKGROUND

While some merchants privately own and operate a publicly available website to transact e-commerce for the sale of the merchant's own personalized-brand goods, some e-commerce websites instead act as a generalized “host” for many different merchants selling a multitude of products to consumers. Sometimes, the e-commerce host also acts as a merchant of self-branded goods on the same site. A merchant on the host website may be an original manufacturer directly selling the manufacturer's own name brand products, or the merchant may be a secondary retailer selling one or more products from one or more different manufacturers. Furthermore, some merchants may sell products from a variety of different general categories or channels (e.g., clothing, tools, pet supplies, etc.), while others may have a particular focus on one category or even a sub-category, or possibly even a single product line. Regardless of whether the merchant has products in multiple categories or just one, a single channel or category for an e-commerce web site generally hosts multiple products offered for sale.

Frequently, e-commerce web sites that host merchants derive revenue from the merchants in multiple ways. For example, the e-commerce website may charge a listing fee when a merchant uses the website as a mediator to host a product for sale, regardless of whether any products are actually sold (i.e., merchants pay for the service and support provided). Another example is that when listed products do sell, the e-commerce website may charge a percent of the sale cost for mediating the transaction. Thus, despite the revenue from the listing fees being charged, there is just as much incentive for the merchant to sell products as there is for the e-commerce website because sales drive the listings. If, however, the e-commerce website is unable to attract users who become customers, no sales will be made. As such, effective promotional advertising is important to both the e-commerce web site and the merchant.

One way to capture the user's attention is to provide a search feature on the e-commerce site. Specifically, when a user of the e-commerce website desires to find a particular product, one common means is by using a search input feature to search the entire inventory or to search within a category of available products associated with the keyword used in the search. Once a search is made, the e-commerce host has an idea of what related products may be enticing to the user and may try to promote those products. In yet another situation, the user may not be looking for anything specific, but may simply be browsing for products that suddenly appeal to the user based on personal interests or a promotional price. In any event, based on the fact that there are so many merchants selling so many products, and a finite space in which to display the products for a finite amount of the user's time, it is clear that it is not possible to display every product. Moreover, it would not be prudent to attempt to display every product, as the sheer quantity of products available would not fit on a user display to the extent that a user could effectively browse the products, and may cause no sale to occur at all.

To address the issues described above, the e-commerce host website may employ a category operator to manually select a product for promotional display (or multiple products depending on the space available for display on the user device, for example, a mobile device with a small screen may display only one or two items). This manual selection is likely based on the operator's best guess of what will sell from past experience. Alternatively, the operator may be provided with specific instructions from the merchants selling the products, informing the operator of what the merchants believe should be promoted via the selective advertisement display. However, as the size of the pool of products in the category increases, this manual task becomes increasingly more difficult.

Furthermore, despite a merchant's desire to sell a particular product, or an operator's belief that a particular product should be promoted, the particular product may be priced too high or it may not be good quality, or the merchant may be known to be unreliable, or the product might not sell well for other reasons. In any of these situations, not only does the promotional display of that product from that merchant end up being a waste of the advertising space resource and the merchant's resources, but the e-commerce host gains little or no value for having promoted an undesirable product, as well.

Accordingly, the methods of product selection for promotional advertisement described above do not provide the most effective results for the e-commerce host or the merchants.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates a system causing a selected product to display on a user display according to an embodiment of this application.

FIG. 2 illustrates a method of ideal product selection for promotional display according to an embodiment of this application.

FIG. 3 illustrates an embodiment of a method of determining a most relevant group of merchants according to this application.

FIG. 4 illustrates an embodiment of a method of determining a most relevant group of users for a merchant according to this application.

FIG. 5 illustrates another embodiment of a method of determining a most relevant group of users for a merchant according to this application.

FIG. 6 illustrates a method of ideal product selection for promotional display according to an embodiment of this application.

### DETAILED DESCRIPTION

### Overview

This disclosure is directed to a system and method of ideal product selection for the purpose of promotionally displaying information regarding the ideal product on a webpage of an e-commerce website. More specifically, one goal of an e-commerce web site may be to act as a third party online intermediary host for merchants selling products to public consumers (“users” of the e-commerce web site). Generally, the e-commerce sites receive nominal funds for merely hosting the merchant's products for sale, regardless of a sale. However, frequently, the host may make more money, after hosting the products, at the time a sale is made because the host may receive a percentage of the sale price as a further cost of providing the sale venue for the merchant. Thus, the success of the merchants equals the success of the e-commerce site.

Much of the success in making a sale revolves around ensuring that the right products are being promoted so as to be readily visible to the right groups of people. Take for example, an analogous situation of a restaurant business advertising its food. Assume the restaurant is a new pizza joint that recently opened in a small, low-income town, and despite having a few other items available for sale, the primary business is to sell $5 pizzas. If the pizza joint is currently boldly promoting a $100 Kobe beef steak dinner outside of the $5 pizza joint, the chances of someone ordering the steak dinner are probably very low unless there is a reputation for the steak, which is unlikely since the restaurant just opened. Further, the blatant promotional advertising of the expensive steak dinner may deter potential patrons from even investigating the new pizza joint for the pizza. Now, not only will the steak dinner not likely sell, but the pizza may not either, despite the stronger probability that the potential patrons would have bought pizza if they hadn't been deterred by the promotion of the steak dinner. This does not mean that the steak dinner is not good, or that is not worth $100, or even that the pizza joint patrons do not like steak or would not enjoy the steak. Moreover, the lack of the sale of the steak dinner also does not alter the fact that, in many ways, the steak dinner and the pizza dinner are related (e.g., both are edible, made for consumption, remedy hunger, can be categorized as “food,” etc.). However, if the majority of the patrons or local residents simply prefer cheap pizza over expensive steak, then the steak is being improperly promoted, even if there is a chance that a single patron might purchase the steak. That is, if the promotion of the steak brings in one patron at $100, but 100 patrons are deterred from ordering pizza for $5 due to the lack of promotion of the pizza, the owner of the pizza joint loses out on the potential $500 in pizza transactions that the owner could have made if the right product had been promoted to the right people.

In another example, assume a shopping mall hosts a variety of merchants, including several clothing merchants amongst others such as a jewelry merchant, a game merchant, a watch merchant, and a greeting card merchant. Assume further that an analysis of data from a survey of the most frequent shoppers at the mall showed that a majority of the shoppers are middle aged women shopping for clothing for themselves. Having this data provides the owner/marketing agent of the mall with a valuable tool to determine what product should be given priority for promotion in order to bring in customers that are most likely to make sale transactions in the mall. Furthermore, by getting the frequent customers—the middle aged women—to return to the mall based on something they really desire, this also provides the other less frequented merchants with product visibility.

Accordingly, it is in the best interests of both the merchants and the owner of the e-commerce site to promotionally display those products that will be most likely to attract the users who are most likely to visit the webpage to buy the products. Thus, the features described in this application alleviate the burden on the merchant and the channel operator of manually selecting which product(s) to promote, by implementing a method on a computer to analyze large amounts of data very rapidly in order to determine the right product(s) to promotionally display to the expected and targeted groups of users/visitors of the webpage.

In a non-limiting embodiment of the instant application, product selection may be performed by a system that identifies one or more particular products, for the purpose of promotional advertisement, from among a plurality of products offered by one or more merchants considered to be the most relevant merchants selling on a particular channel or category of an e-commerce web site.

As previously indicated, each channel or category (or “webpage”) of an e-commerce web site may host many products from a large plurality of merchants. Thus, in order to determine the ideal product to display in the limited display space to a user visiting the e-commerce site, the plurality of merchants may be analyzed to limit the number of merchants and, therefore, also the number of products from which to select a product. This analysis of the merchants may include a determination of a group of the most relevant users for each of the merchants for a particular channel or category.

By way of reference and for the purposes of explanation in this specification, use of the terms channel, category, and channel/category webpage herein may refer to a single URL page or a series of hierarchical URL pages that are linked to each other based on a common relationship. Further, the terms channel, category, and channel/category webpage may be used interchangeably to refer to the same concept, or may be used distinctly. However, if used distinctly, such will be readily detectable based on the context in which the terms are used. For example, a channel may refer to a portion of the parent e-commerce company's website that is dedicated to a particular region or country (e.g., a U.K. culture-oriented version in English of a Chinese-based parent e-commerce website). Alternatively, the term channel may simply refer to a particular group for products focused on that group, which is a branch of the main parent e-commerce website (e.g., a teens channel having multiple product categories promoting products targeted only to teenagers).

By identifying the most relevant users, further analysis of the merchants is facilitated because the profile information of the most relevant users may provide insight regarding which merchants receive the most web traffic and sales from a particular targeted user base. The most relevant merchants may then be identifiable based on how closely the group of most relevant users matches the target users of the channel or category.

After determining which merchants are most relevant, a further identification of the most relevant product(s) is conducted. The identified product(s) may then be displayed on the webpage to attract targeted users. Thus, unlike a system that tries to analyze each individual user's search history to target only that specific user directly with a placed advertisement potentially related to a previous search, a feature of the instant application is to determine which merchant(s) are most effective in attracting relatively large groups of targeted users and then identifying one or more ideal products from the selected group of merchants for general promotional display.

Thus, rather than expending efforts on an individual user level, the method and system of the instant application seeks, at least in part, to utilize the promotional advertising space to more effectively select one or more products for display that will appeal to a greater audience overall. That is, in some instances, the system described herein involves steps to capture the attention of a larger group of visitors to the channel or category webpage by way of an analysis process that predicts more accurately which users are most likely to revisit the web site and which product(s) would be most appealing to those users.

### Illustrative Embodiment of a System for Ideal Product Selection for Promotion

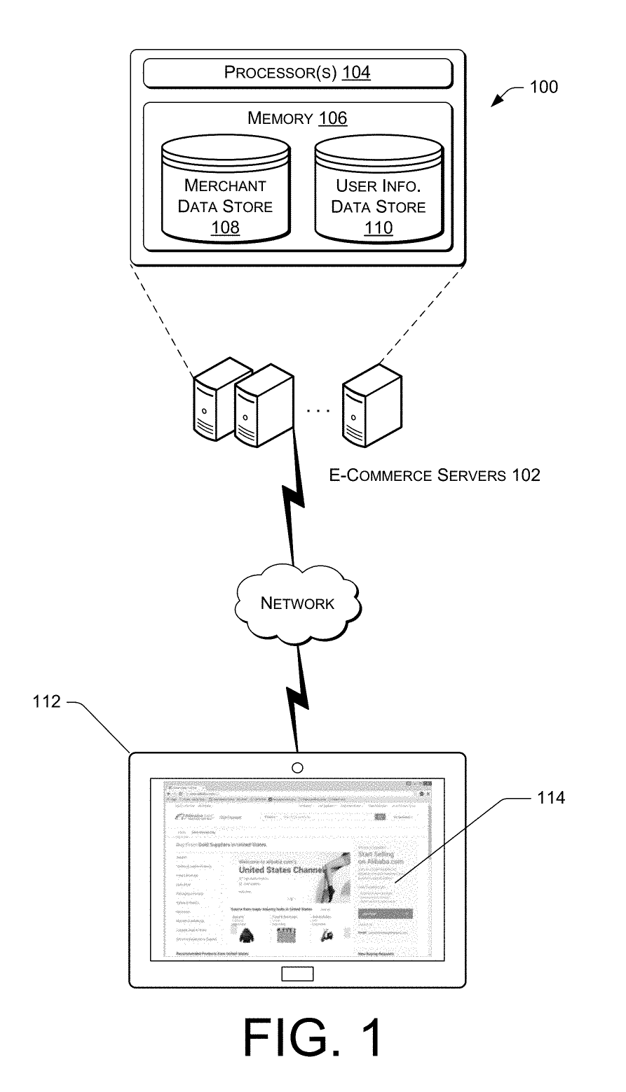

In FIG. 1, a system 100 for determining the ideal product for promotional display is depicted. Specifically, the system 100 may include one or more servers 102, via which the business transactions of the e-commerce website may be conducted. The servers 102 may include one or more processors 104 and memory 106 including instructions to cause the one or more processors 104 to perform a method to achieve the features of this application. The memory 106 may include a merchant data store 108 containing information regarding each merchant and the products that the merchants sell. The memory 106 may further include a user information data store 110, which contains information such as user profile data indicating personal characteristics of the users, user activities/behaviors online with respect to the merchants, user shopping habits for each merchant on the channel or category of the e-commerce site, etc.

The memory 106 may include computer-readable media in the form of volatile memory, such as random-access memory (RAM) and/or non-volatile memory, such as read only memory (ROM) or flash RAM. The memory 106 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Servers 102 may be connected to any type of web-accessible device such as user device 112 via a network that supports transmission of online data for display on the user device 112. For example, a user may open an application on the user device 112 with which the user accesses a channel/category webpage 114 of an e-commerce web site. The channel/category webpage 114 may display a promotional advertisement of one or more products to the user via the user device 112. The user may click on the promotional advertisement and be directed to further information regarding the promoted product(s) and/or other related products, thereby increasing the chance of a sale transaction occurring between the merchant and the user.

Specifically, in a non-limiting, example embodiment the one or more processors 104 may be communicatively coupled with the memory 106, and the memory 106 may include instructions, which when executed, causes the one or more processors 104 to perform steps of a method for determining an ideal product or products for promotional display on the user device 112. The steps of the method may include analyzing the online user profile data of users stored in the user information data store 110 to determine the most relevant group of the users for each of a plurality of merchants selling a product on a channel/category webpage 114 of the e-commerce website.

The method steps may further include comparing the users of the most relevant group to a targeted user group of the channel/category webpage 114 to determine a rate of overlap for each merchant. The rate of overlap may be determined based on a portion of the users of the most relevant group that fit criteria of the targeted user group. The plurality of merchants may then be ranked, from highest to lowest, based on the rate of overlap. Additionally, the instructions in memory 106 may cause an analysis of the products being sold by a portion of the plurality of merchants using a price sensitive merchandise selection model that is a learning model using a gradient boosting decision tree (“GBDT”) model. Once the one or more products for display are determined, as indicated above, the system 100 may cause display of, on the channel/category webpage 114 of the e-commerce website, information of one or more of the analyzed products from one or more of the portion of the plurality of merchants.

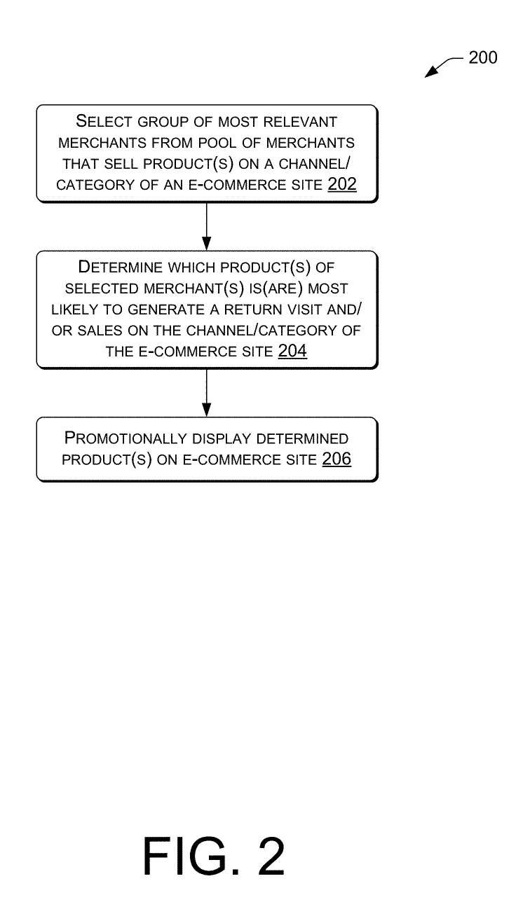

More detailed information regarding the features of the method executed by system 100 and contained on memory 106, as discussed above, may be found described herein with respect to FIGS. 2-6.

### Illustrative Embodiments of a Method for Ideal Product Selection for Promotion

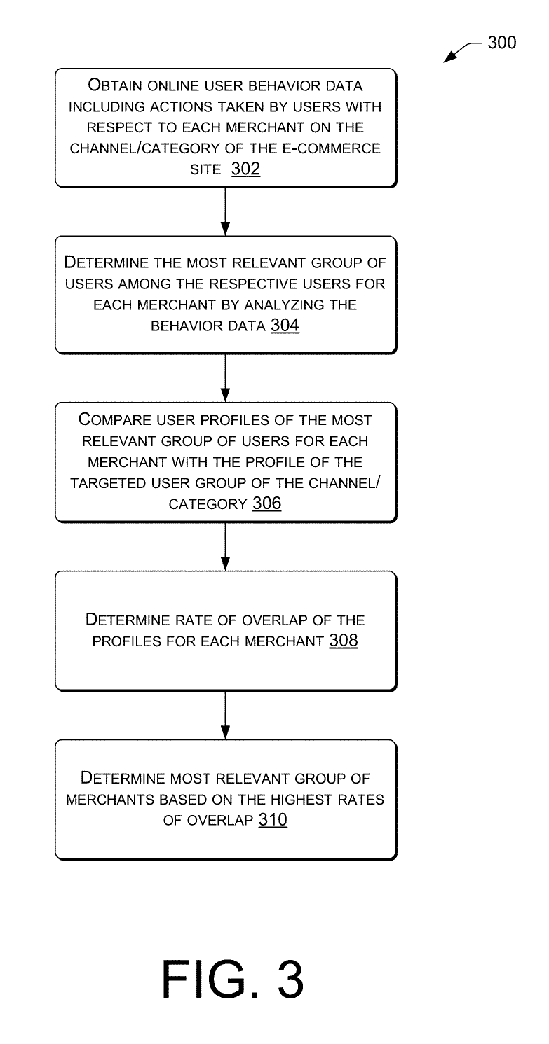

In an embodiment of the instant application, FIG. 2 depicts features of a method 200 for identifying and subsequently promotionally advertising one or more ideal products on an e-commerce website. For example, method 200 may include a step 202 of selecting a group of the most relevant merchants from pool of merchants that sell one or more products on a channel/category webpage of an e-commerce web site. The selection of the group of most relevant merchants may be performed in many ways. Additional feature details of some of the potential embodiments of selecting the group of most relevant merchants to the channel/category webpage are described herein below with respect to FIGS. 3, 4, and 5.

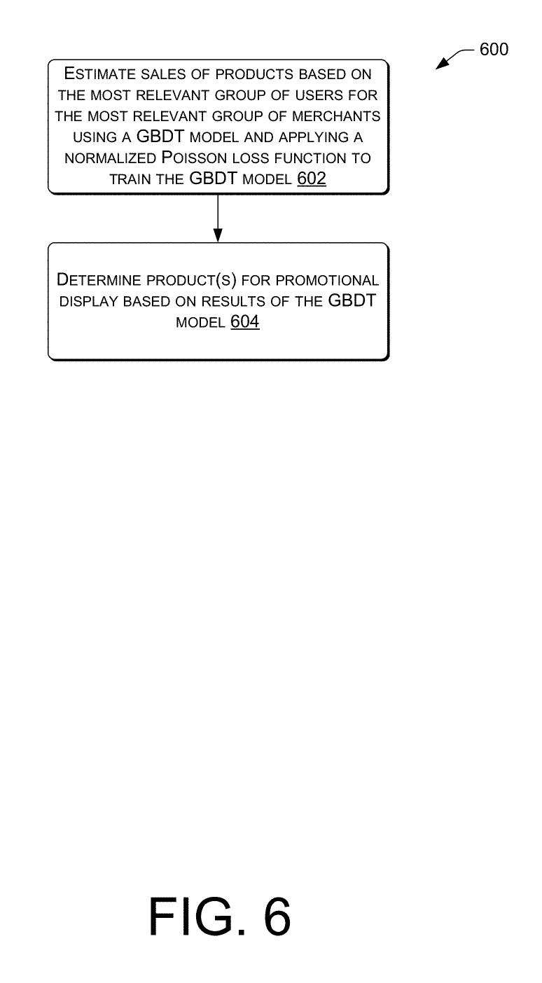

Method 200 further includes a step 204 of determining which products being sold by merchants within the group of the most relevant merchants are most likely to generate a return visit and/or sales by the targeted users of the channel/category webpage of the e-commerce site. Here again, there are many ways to determine the ideal product(s) to promotionally display. Additional feature details of one of the potential embodiments of selecting the ideal product(s) to promote on the channel/category webpage is described herein below with respect to FIG. 6. Step 204 of identifying the product(s) to promote is intentionally performed after step 202 of identifying the most relevant group of merchants because the product determination may be more accurate as the quantity of products analyzed is more focused by the fewer merchants that have been selected as the most relevant.

In step 206, after having determined which product(s) may be most likely, or at least more likely, to attract the attention of the targeted users and induce the targeted users to visit and/or purchase from the channel/category webpage, the product(s) is(are) promotionally displayed on the e-commerce website to advertise the availability of the product(s). In some instances, the promotional display may be displayed on the main home page of the e-commerce web site and may be associate with a link directly to the product(s) being promoted, or with a link to a particular channel or category webpage of the e-commerce website. In other instances, the promotional display may be displayed directly on the main channel or category webpage of the e-commerce website with which the promoted product is associated. Furthermore, while the promotional display of the product(s) may be displayed generally for all users to see, the product(s) may, alternatively, or additionally, be displayed directly to targeted users for whom the promotional display was ultimately intended to reach.

FIG. 3 depicts an embodiment of a method 300 of determining the most relevant group of merchants. In some instances, method 300 includes a step 302 of obtaining online user behavior data. The behavior data may include user profiles of personal information and user profiles of actions taken with respect to each merchant on the channel/category of the e-commerce website. The actions data may include one or more of: visiting the channel/category webpage, searching while on the channel/category webpage, clicking product-related hyperlinks while on the e-commerce website, adding products to a virtual shopping cart while on the channel/category webpage, purchasing the products in the virtual shopping cart, ranking or commenting on products on the channel/category webpage, etc. Other online behavioral actions may be analyzed as well. This behavior data may be provided by the merchant or may be obtained by tracking user behavior patterns and activities on the e-commerce website. Alternatively, the behavior data may also be provided by the operators of a third party website or service providers who may have historical online behavior data for the users.

In step 304, the behavior data may be analyzed to determine the most relevant users among the respective users for each merchant. In some embodiments, every user that has an interaction with a particular merchant becomes part of a pool of users associated with that particular merchant. In general, the users in each pool of users may be scored and ranked or ordered according to a level of relevancy with respect to the particular merchant, from the most relevant to the least relevant. Inasmuch as a user may interact somehow with multiple merchants on varying levels, a single user may be analyzed several times as a part of multiple pools of users for respective multiple merchants. Because the ultimate goal of this application is to identify one or more products that are associated with a specific channel/category webpage, the product selection is associated with the merchants who draw in the most users who are most aligned with the target user group of the channel/category webpage. Thus, step 304 provides an improved understanding of the type of users each merchant is more likely to attract.

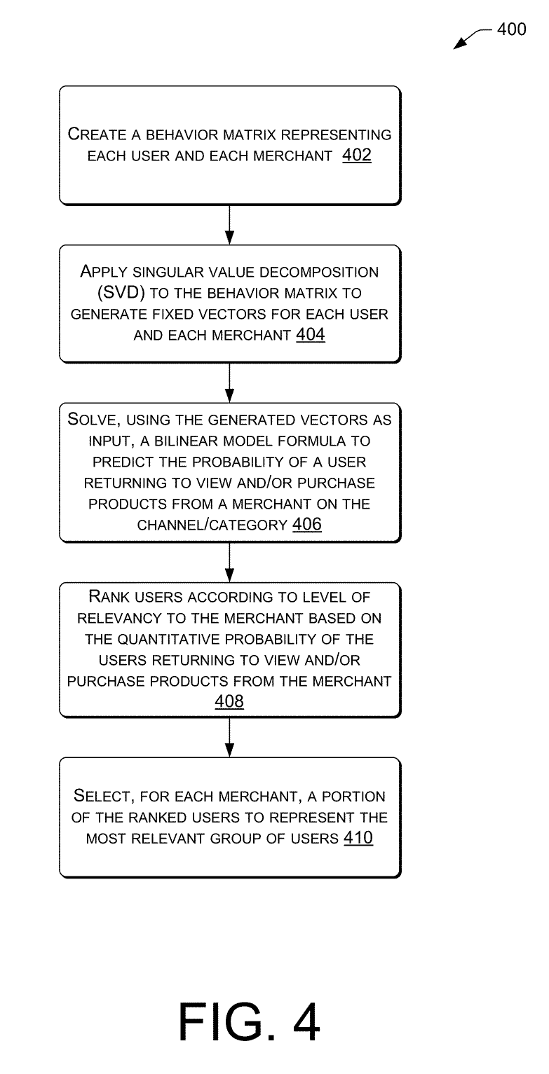

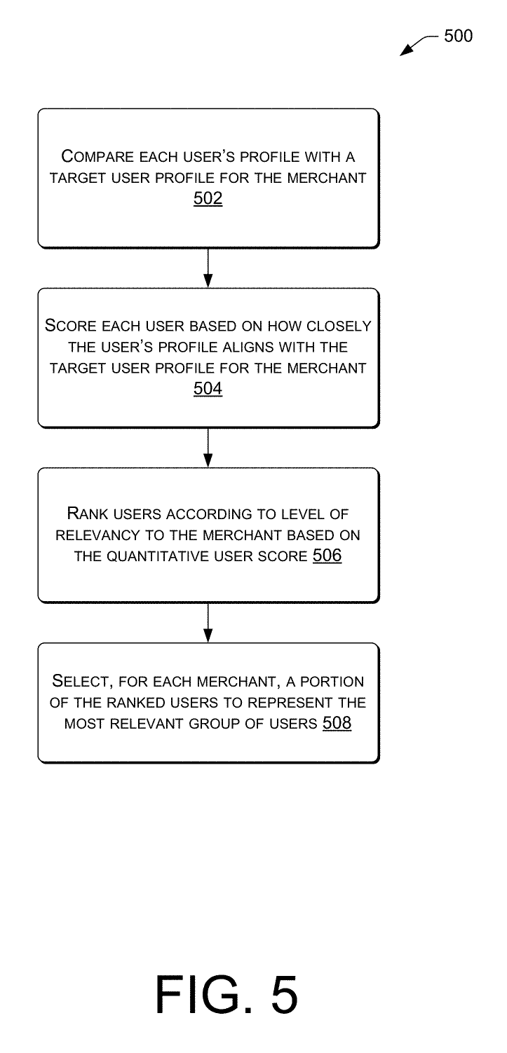

With regard to the level of relevancy, a user belonging to the group of the most relevant users may be a user who the system predicts has a high likelihood of at least returning to visit the particular merchant for which data was analyzed. The selection of the group of most relevant users may be performed in many ways. Additional feature details of some of the potential embodiments of selecting the group of most relevant users for each merchant are described herein below with respect to FIGS. 4 and 5.

Note that while all of a merchant's users (tracked over a predetermined time period) are analyzed, for the purposes of this application, only the data of a top portion of the users according to a level of relevancy is considered to be part of the most relevant group of users. The top portion, as described herein, may refer to a predetermined percent or number of all of the users in a pool of users, starting with the highest scoring users and including progressively lower scoring users until the group of most relevant users satisfies the overall predetermined percent or number of users from the respective pool of users. That is, if the predetermined number of users for the most relevant group of users is 1000, then for a merchant that has a list of 5 million associated users, only the top highest scoring 1000 users, may be considered to be the most relevant group of users, regardless of the overall size of the pool of users. As previously stated, further details of the analysis of the users with respect to the merchants is discussed herein below.

Method 300 may further include a step 306 of comparing the user profiles, obtained in the behavior data, of the most relevant group of users for each merchant with the profile of a targeted user group of the channel/category webpage. The profile of the targeted user group may be predetermined by the channel/category operator. In some instances, the targeted user group may be defined by a specific user interest in the general product theme of the channel/category webpage. Additionally, or alternatively, the targeted user group may be defined by other personal characteristics such as, for example, the age and/or gender of the targeted user. In other instances, the targeted user group may be defined based on historical online shopping behavior of the user.

Upon determining who are the most relevant users of a merchant in step 304, the result may show that, of all the users evaluated for a merchant, a large portion of the users are more interested in a product that, although offered by the merchant, is not within the class of products generally available or promoted on the channel/category webpage. For example, merchant A might sell a line of hair care products on a channel X, where channel X generally is directed to personal hygiene products. Merchant A may also sell backpacks on a different channel Y directed to outdoor products. Despite this diversity of products, all of the users of merchant A are analyzed when the ideal product selection method of the instant application is implemented with respect to channel Y. If most of merchant A's business comes from the hair care products on channel X and the users buying the hair care products also do not take actions online related to the merchant's backpack side of the business on channel Y, the behavior data analysis may show that the profile data of the most relevant group of users for merchant A does not align with the target user profile for channel Y. Thus, in implementing the instant method to determine ideal promotional products for display on channel Y, the comparison (in step 306) of the user profiles of the most relevant group of users for merchant A with the target user profile for channel Y may show very little overlap among the users of merchant A. Accordingly, merchant A may not be relevant to the product selection process for the promotion of products on channel Y.

Using the result of the comparison of the user profiles with the profile of the targeted user group, in step 308, the rate of overlap of the profiles is determined for each merchant. In some instances, the rate of overlap considers how many of the users of the most relevant group of users for each merchant are also considered to be targeted users of the channel/category webpage compared to the total number of users of the respective most relevant group of users for the respective merchant. For example, assume that the top 1000 scoring users of merchant A were selected as the most relevant group of users. Further, assume that of those 1000 users, 625 users would also be considered target users according to the targeted user profile of the channel/category webpage being analyzed. Under these circumstances, the rate of overlap for merchant A is 62.5%. Thus, the rate of overlap is determined for each merchant by calculating the percent of the overlapping users within the total number of users in the most relevant group of users for each merchant.

Then, in step 310, the most relevant group of merchants may be determined based on the highest rates of overlap. That is, for a particular channel/category webpage, similar to the determination of the most relevant group of users, to determine the most relevant group of merchants, all of the merchants are scored and ranked or ordered from highest relevancy to lowest relevancy with respect to the channel/category webpage according to the scored rate of overlap. Further, again like in the determination of the most relevant group of users, only the data of a top portion of the merchants according to the level of relevancy is considered to be part of the most relevant group of merchants. The top portion, as described herein, may refer to a predetermined percent or number of all of the merchants among the merchants selling a product on the channel/category webpage. This top portion starts with the highest relevancy scoring merchants and includes progressively lower relevancy scoring merchants until the group of most relevant merchants satisfies the overall predetermined percent or number of merchants among all merchants on the channel/category webpage. That is, if the predetermined number of merchants for the most relevant group of merchants is 500, then for a channel/category webpage that hosts 10,000 merchants, only the top highest scoring 500 merchants, may be considered to be the most relevant group of merchants, regardless of the overall substantially greater total number of merchants selling products on the channel/category webpage.

Returning to step 304, FIGS. 4 and 5 represent further details of different, yet related embodiments of how to analyze different types of user behavior data to determine the most relevant group of users for each merchant.

For example, in an embodiment of the instant application, FIG. 4 describes a method 400 including step 402, in which a behavior matrix is created. The behavior matrix represents the relationship between each user and merchant with respect to a channel/category webpage. The value inputs in the matrix are data values derived from online behavior actions of the users with the merchants. The data values may represent, in some instances, the number of times a user clicked on any webpage or hyperlink associated specifically with a particular merchant or products offered by the particular merchant. Alternatively, the data values may represent a scored sum of multiples of point values assigned to specific distinct actions taken by a user with respect to the particular merchant. For example, in an embodiment, the point value of a user clicking once to merely visit the channel/category webpage may be worth less than the point value of a user performing a search while on the channel/category webpage, which in turn may be worth less than the point value of a user actually clicking product-related hyperlinks while on the on the channel/category webpage, and so on. Thus, the number of times each of these actions are taken by a user with respect to a particular merchant may be tracked and tallied before multiplying the respective tallies for each action by the assigned point values. Then, the results of the multiplication are summed for a grand total, and the total may be used as the data input in the matrix for that user with respect to the particular merchant.

The data values for the matrix may be determined in additional manners without departing from the scope of the invention with respect to the feature of step 402, which is to create a behavior matrix indicating some valued relationship between the merchants and the users. Note that where a user has had no interaction with a particular merchant, the data value entry for that space in the behavior matrix is zero.

The matrix may be solved using the mathematical technique of Singular Value Decomposition (“SVD”) in step 404 to generate fixed vectors for each user (uᵢ) and each merchant (mⱼ). The output may therefore be represented as such u₁:f₁, u₂:f₂ . . . uᵢ:fᵢ and m₁:g₁, m₂:g₂ . . . mⱼ:gⱼ respectively. Next, using the generated fixed vectors as input, a bilinear model formula is solved in step 406 to predict the probability of a user returning to view and/or purchase one or more products from the particular merchant on the channel/category webpage. The predicted probability may be considered to be a relevance score, as described in detail below.

In general, the goal of the bilinear model is to assess the relationship between a user i and a merchant j. Each user i may be represented by a vector uᵢ∈R^{d}^{ᵤ} and each merchant j may be represented by a vector vᵢ∈R^{d}^{ᵥ}. Moreover, the interaction between a user-merchant pair (i, j) may be represented by a vector kᵢⱼ of dimension dₖ. Then the relevance score between user i and merchant j may be calculated as f(xᵢ, yⱼ, Kᵢⱼ)=uᵢ^{T}Mvⱼ+m^{T}Kᵢⱼ, where matrix M and vector m are the models that are to be trained.

To this end, assume that for each merchant j, the vector representation of the nⱼ users preferred by merchant j may be denoted by wᵢ^{j}, . . . , wₙ_{ⱼ}ⱼ, and the vector representation of mⱼ users that are not preferred by merchant j may be denoted by u₁^{j}, . . . , uₘ_{ⱼ}^{j}. Further, to learn M and m, for each merchant j, a loss function hⱼ(M, m) may be constructed as:

$${h}_{j} ( M , m ) = {\sum }_{i = 1}^{{n}_{j}} l ( {max}_{1 \leq k \leq {m}_{j}} ( {u}_{k}^{{j}^{T}} {Mv}_{j} + {m}^{T} {K}_{kj} - {w}_{i}^{{j}^{T}} {Mv}_{j} - {m}^{T} {K}_{ij} ) ) ,$$

where l(z)=[1+z]₊². The optimal M,m are found by minimizing the regularized loss over all the merchants by:

$${min}_{M , m} \frac{λ}{2} ( {\vert \vert M \vert \vert}_{F}^{2} + {\vert \vert m \vert \vert}^{2} ) + {\sum }_{j} {h}_{j} ( M , m ) .$$

Then, standard methods such as, for example, gradient decedent or Nesterov's method may be used to solve the optimization problem.

Accordingly, after determining the respective levels of relevancy (or the probability of a user returning), step 408 ranks users according to the level of relevancy to each particular merchant. In step 410, the predetermined portion (percentage or number) of the ranked users may be selected to represent the most relevant group of users, which relates to step 304 of FIG. 3.

As an alternative form of determining the most relevant group of users to the merchants, FIG. 5 depicts an embodiment of a method 500 including a step 502 of comparing each user's profile with a target user profile for the merchant. In contrast to the user behavior data used as a basis for determination of the most relevant group of users in the method 400, the user behavior data used in method 500 is not related necessarily to the number of clicks or online actions taken with respect to the merchant. Instead, the user behavior data used in method 500 may include more personal data of the user, such as age, gender, likes, dislikes, shopping habits, interests, hobbies, etc. Likewise, the merchants may define a particular target user profile listing several target characteristics or features of target users. In this instance, some of the user's personal data may not be readily available or detectable based on online usage history. However, in some instances, the system of the instant application may be provided with that data from the user directly or the system may cull the internet traffic of users to try to extract as much of the personal user data as possible to be able to make a reasonable comparison of a user's profile to the target user profile.

In step 504 of FIG. 5, each user may be given a score based on how closely the user's profile aligns with the target user profile for the merchant. The resulting score may represent a level of relevancy for each user with respect to the merchants. For example, in some instances, a summation of points may be calculated for single or varying points values assigned to each matching characteristic between the user's profile and the merchant's target profile. That is, certain characteristics may be weighted more heavily in points than others, or each characteristic may only be worth a single point.

After scoring, the users are ranked according to the respective levels of relevancy from greatest relevancy to least relevancy based on the score for each user, in step 506. Then, similar to step 410, in step 508, the predetermined portion (percentage or number) of the ranked users may be selected to represent the most relevant group of users, which relates to step 304 of FIG. 3.

With respect to FIG. 6, a method 600 of determining the product(s) that may be promotionally displayed is described in steps 602 and 604. Specifically, in step 602, sales of products are estimated for each merchant of the most relevant group of merchants. The estimation may be calculated using a price sensitive merchandise selection model that is a learning model. For example, the price sensitive merchandise selection model may be implemented using the mathematical technique of a gradient boosting decision tree (“GBDT”) model to improve product selection. Furthermore, while the GBDT model is a useful mathematical technique to evaluate the data of the most relevant group of merchants, in some instances, the GBDT model may be modified by applying a normalized Poisson Loss Function to train the GBDT mode to further enhance the selection process.

In an example embodiment of the instant application, the GBDT model and the normalized Poisson Loss Function may be further described as follows.

The goal of the merchandise selection model is to do product selection based on optimization criteria from a pool of products, each of which is manipulated to be represented as a fixed dimensional vector. The data of the pool of products may be generated, for example, from prior user behavior on each item, consumer reviews, seller capacity of the item, and corresponding category information, etc. As such, each item i is represented by a vector xᵢ∈R^{d}. Since the GBDT model is a tree-structure model and consists of a bunch of weak learners fᵢ, each of which is a tree, the output of the merchandise selection model is a score for each item. Thus, in the GBDT model calculation, the output has the following formula:

f(x)=Σᵢ₌₀^{k}fᵢ(x).

Moreover, for different channels, the operators may have different product selection tasks, such as a task to maximize the gross merchandise value (“GMV”) or Click Through Rate (“CTR”). That is, different loss functions may be used on different targets. For example, if a merchant desires to select products that may maximize the GMV, GMV may be chosen as target Y, to do optimization tasks based on the GBDT model, the formula for which may be as follows:

$${min}_{{f}_{i}} L ( Y , {\sum }_{i = 1}^{m} {f}_{i} )$$

Since the product selection of step 602 is basically based on sales forecasting, when training the GBDT model, a normalized Poisson loss function may be used as an optimization objective function. Thus, the normalized Poisson loss function may have the following formula:

L(q, y)=e^{q-y}−1−q−y

where y=log(Y), q=log(Q), while Y is the observed quantity, and Q is the output of model.

In some instances, the normalized Poisson loss function has a property of modeling product sales without over-estimating or under-estimating the quantity. In combination with the learned model, scoring may be done for each item. Furthermore, based on the scoring of the products, the product(s) for promotional display may be determined, in step 604.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A computer-implemented method for selecting an ideal product to display on a webpage of an e-commerce website, acts of the method comprising:
obtaining online user behavior data of users associated with a plurality of merchants selling products on the webpage, each merchant being associated with a pool of users, and the behavior data including digital information of actions performed online by the users in the respective pools of users with respect to individual merchants;
analyzing the behavior data for each merchant to determine a most relevant group of the users within each pool of users for each merchant;
comparing respective profiles of the users of the most relevant group to a profile of a targeted user group of the webpage to determine a rate of overlap for each merchant, the rate of overlap representing a percentage of the users of the most relevant group having a profile that matches the profile of the targeted user group;
selecting a top merchant from among the plurality of merchants based on a highest rate of overlap;
selecting a top product being sold by the top merchant to display on the webpage; and
causing display of, on the webpage of the e-commerce website, the top product to an end user having a profile that coincides with the profile of the targeted user group.

2. The method according to claim 1, wherein the actions performed by the users on the webpage online include one or more of: visiting the webpage, searching while on the webpage, clicking product-related hyperlinks while on the e-commerce website, adding products to a virtual shopping cart while on the webpage, purchasing the products in the virtual shopping cart, and ranking or commenting on products on the webpage.

3. The method according to claim 1, wherein the act of analyzing the behavior data includes acts of:
creating a behavior matrix representing each user and each merchant, and
applying singular value decomposition (“SVD”) to the behavior matrix to generate truncated singular fixed vectors for each user and each merchant.

4. The method according to claim 3, wherein the act of analyzing the behavior data further includes:
an act of solving, using the generated vectors as input, a bilinear model formula to predict a probability of a particular user returning to view and/or purchase products from a particular merchant on the webpage.

5. The method according to claim 1, wherein the act of analyzing the behavior data includes acts of:
ranking users based on the behavior data according to a level of relevancy to each merchant, the level of relevancy increasing as a probability of a particular user returning to view and/or purchase products from a particular merchant on the webpage at a later time increases, and
selecting, for each merchant, a portion of the ranked users to represent the most relevant group of the users, the portion of the ranked users including highest ranked users.

6. The method according to claim 1, wherein the act of selecting the top product includes acts of:
estimating sales of products based on the most relevant group of the users for the top merchant using a price sensitive merchandise selection model that is a learning model using a gradient boosting decision tree (“GBDT”) model to improve product selection, and
selecting the top product based on estimated sales results obtained from the price sensitive merchandise selection model.

7. The method according to claim 6, wherein the act of estimating sales of products includes applying a normalized Poisson loss function to the GBDT to train the price sensitive merchandise selection model.

8. A system for selecting a product to display on a webpage of an e-commerce website, the system comprising:
one or more processors; and
memory communicatively coupled with the one or more processors, the memory including instructions, which when executed, causes the one or more processors to perform the following acts:
analyzing online user profile data of users to determine a most relevant group of the users for each of a plurality of merchants selling a product on the webpage,
comparing the users of the most relevant group to a targeted user group of the webpage to determine a rate of overlap for each merchant, the rate of overlap being determined based on a portion of the users of the most relevant group that fit criteria of the targeted user group,
ranking the plurality of merchants, from highest to lowest, based on the rate of overlap,
analyzing the products being sold by a portion of the plurality of merchants using a price sensitive merchandise selection model that is a learning model using a gradient boosting decision tree (“GBDT”) model, and
causing display of, on the webpage of the e-commerce website, information of one or more of the analyzed products from one or more of the portion of the plurality of merchants.

9. The system according to claim 8, wherein criteria of the targeted user group is pre-selected by an operator of the webpage.

10. The system according to claim 8, wherein the webpage is one of a main channel page of the e-commerce website, a main category page of the e-commerce website, or a sub-category page of the e-commerce website.

11. The system according to claim 8, wherein the instructions, when executed, cause the one or more processors to further perform an act of:
determining a most relevant group of merchants prior to analyzing the products, the most relevant group of merchants including a predetermined number or a percent of highest ranked merchants of the plurality of merchants.

12. The system according to claim 8, wherein user profile data includes personal characteristics of the users.

13. The system according to claim 8, wherein the user profile data includes user activity on the webpage including a number of user clicks on the webpage.

14. The system according to claim 8, wherein the GBDT model incorporates a normalized Poisson loss function to train the price sensitive merchandise selection model and score the products for selection.

15. One or more computer-readable media storing computer-executable instructions that, when executed by one or more processors, instruct the one or more processors to perform acts comprising:
selecting, from among a plurality of products for sale on a webpage of an e-commerce website that mediates sale transactions between users and a plurality of merchants, one or more most relevant products for a promotional display to a targeted user group, the most relevant products being sold by one or more of the plurality of merchants belonging to a most relevant group of merchants, the selecting including:
determining a most relevant group of users with respect to each merchant of the plurality of merchants selling a product available on the webpage,
determining the most relevant group of merchants on the webpage based on the determination of the most relevant group of users, and
analyzing products on the webpage for sale by the most relevant group of merchants using a price sensitive merchandise selection model that is a learning model using a gradient boosting decision tree (“GBDT”) model; and
causing display of, on the e-commerce website, the one or more most relevant products to the targeted user group.

16. The one or more computer-readable media according to claim 15, wherein the GBDT model analyzes the products based on product data including information of at least one of price, review, page views, or gross merchandise volumes.

17. The one or more computer-readable media according to claim 15, wherein the act of determining the most relevant group of users includes acts of:
determining a level of relevancy of each user to each merchant based on criteria of historical shopping behavior actions taken by each user with respect to each merchant, different actions taken indicating varying levels of relevancy,
organizing the users according to the respective levels of relevancy from greatest relevancy to least relevancy, and
selecting a predetermined number or percentage of the users having the greatest relevancy to be the most relevant group of users.

18. The one or more computer-readable media according to claim 17, wherein the act of determining the level of relevancy uses a bilinear model to mine a relationship between each user and each merchant.

19. The one or more computer-readable media according to claim 18, wherein the bilinear model is represented as
f(xᵢ, yᵢ, Kᵢⱼ)=uᵢ^{T}Mvⱼ+m^{T}kᵢⱼ, and
a training criteria for the bilinear model is represented as
$$\begin{matrix}{min}_{M , m} \frac{λ}{2} ( {\vert \vert M \vert \vert}_{F}^{2} + {\vert \vert m \vert \vert}^{2} ) + {\sum }_{j} {h}_{j} ( M , m ) , & \\ where & \\ {h}_{j} ( M , m ) = {\sum }_{i = 1}^{{n}_{j}} l ( {max}_{1 \leq k \leq {m}_{j}} ( {u}_{k}^{{j}^{T}} {Mv}_{j} + {m}^{T} {K}_{kj} - {w}_{i}^{{j}^{T}} {Mv}_{j} - {m}^{T} {K}_{ij} ) ) . & \end{matrix}$$

20. The one or more computer-readable media according to claim 15, wherein an output of the GBDT model is represented as
$$f ( x ) = {\sum }_{i = 0}^{k} {f}_{i} ( x ) .$$
